(19) United States
(12) Patent Application Publication
(10) Pub. No.: US 2026/0279894 A1
(43) Pub. Date: Sep. 17, 2026

(54) Reacted All-Solid-State Battery and Method for Manufacturing Same

(71) Applicant: Nissan Motor Co., Ltd., Yokohama-shi, Kanagawa (JP)

(72) Inventors: Zhenguang Li, Kanagawa (JP); Misaki Fujimoto, Kanagawa (JP); Daisuke lto, Nagaokakyo-shi (JP); Issei Ootani, Kanagawa (JP); Wataru Ogihara, Kanagawa (JP)

(21) Appl. No.: 19/167,208

(22) PCT Filed: Mar. 23, 2023
(86) PCT No.: PCT/JP2023/011416

§ 371 Date: Sep. 19, 2025

(51) Int. Cl. H01M 10/0562; H01M 4/02; H01M 4/58; H01M 4/66; H01M 10/058

(52) U.S. Cl. CPC H01M 10/0562; H01M 4/5815; H01M 4/661; H01M 10/058; H01M 2004/028; H01M 2300/008

(57) ABSTRACT

A reacted all-solid-state battery includes: a positive electrode in which a positive electrode active material layer containing a positive electrode active material containing a sulfur element and a sulfide solid electrolyte containing a sulfur element, a phosphorus element, and a lithium element is disposed on a surface of a positive electrode current collector; a negative electrode in which a negative electrode active material layer containing a negative electrode active material containing an alkali metal element is disposed on a surface of a negative electrode current collector; and a solid electrolyte layer interposed therebetween containing a solid electrolyte. In an X-ray photoelectron spectroscopic spectrum of the positive electrode active material layer, an intensity ratio (A/B) between a maximum peak A within a range of 163 to 165 eV and a maximum peak B within a range of 161 to 163 eV is 0.6 or more and 1 or less.

### TECHNICAL FIELD

The present invention relates to a reacted all-solid-state battery and a method for manufacturing the same.

### BACKGROUND ART

In recent years, research and development on an all-solid-state secondary battery using an oxide-based or sulfide-based solid electrolyte as an electrolyte have been actively conducted. The solid electrolyte is a material mainly made of an ion conductor that enables ion conduction in a solid. For this reason, the all-solid-state secondary battery has the advantage that, in principle, various problems caused by a combustible organic electrolyte solution do not occur unlike the conventional liquid-type secondary battery using a non-aqueous electrolyte. In general, use of a high-potential and large-capacity positive electrode material and a large-capacity negative electrode material can achieve significant improvement in output density and energy density of a battery.

It is known that performance of an all-solid-state secondary battery using a sulfide-based solid electrolyte (hereinafter, also simply referred to as “sulfide solid electrolyte”) is significantly deteriorated by decomposition of the sulfide solid electrolyte when charging and discharging are repeated. In order to solve this problem, for example, WO 2013/084944 A1 discloses a technique in which a negative electrode active material layer is formed using a negative electrode active material having a predetermined operation potential, and the potential of the negative electrode active material layer is controlled so as not to be equal to or lower than the potential at which the reductive decomposition of a sulfide solid electrolyte material occurs. According to WO 2013/084944 A1, it is considered that the charge/discharge efficiency can be improved by preventing the reductive decomposition of the sulfide solid electrolyte material in contact with the negative electrode active material according to the above configuration.

### SUMMARY OF INVENTION

### Technical Problem

However, as a result of studies by the present inventors, in an all-solid-state battery including a positive electrode active material layer containing a sulfide solid electrolyte, it has been found that an increase in cell resistance due to repeated charging and discharging cannot be sufficiently suppressed even by the technique described in WO 2013/084944 A1, and further improvement has been desired.

Therefore, an object of the present invention is to provide a means capable of suppressing an increase in cell resistance in an all-solid-state battery including a positive electrode active material layer containing a sulfide solid electrolyte.

### Solution to Problem

The present inventors have conducted intensive studies to solve the above problems. As a result, it has been found that an increase in cell resistance can be significantly suppressed by charging an unreacted all-solid-state battery that is not charged or discharged as an initial reaction, the unreacted all-solid-state battery including a positive electrode including a positive electrode active material layer containing a positive electrode active material containing a sulfur element and a sulfide solid electrolyte containing a sulfur element, a phosphorus element, and a lithium element. The present inventors analyzed the positive electrode active material layer of the reacted all-solid-state battery by X-ray photoelectron spectroscopy (XPS), and found that the positive electrode active material layer exhibits a predetermined profile in an XPS spectrum, thereby completing the present invention.

That is, one aspect of the present invention is a reacted all-solid-state battery including a power generating element including: a positive electrode in which a positive electrode active material layer containing a positive electrode active material containing a sulfur element and a sulfide solid electrolyte containing a sulfur element, a phosphorus element, and a lithium element is disposed on a surface of a positive electrode current collector; a negative electrode in which a negative electrode active material layer containing a negative electrode active material containing an alkali metal element is disposed on a surface of a negative electrode current collector; and a solid electrolyte layer interposed between the positive electrode and the negative electrode and containing a solid electrolyte, wherein in an X-ray photoelectron spectroscopic spectrum of the positive electrode active material layer, an intensity ratio (A/B) between a maximum peak A within a range of 163 to 165 eV and a maximum peak B within a range of 161 to 163 eV is 0.6 or more and 1 or less.

Another aspect of the present invention is a method for manufacturing a reacted all-solid-state battery, the reacted all-solid-state battery including a power generating element including: a positive electrode in which a positive electrode active material layer containing a positive electrode active material containing a sulfur element and a sulfide solid electrolyte containing a sulfur element, a phosphorus element, and a lithium element is disposed on a surface of a positive electrode current collector; a negative electrode in which a negative electrode active material layer containing a negative electrode active material containing an alkali metal element is disposed on a surface of a negative electrode current collector; and a solid electrolyte layer interposed between the positive electrode and the negative electrode and containing a solid electrolyte, the method including a charging step of charging an unreacted all-solid-state battery, which is not charged or discharged, as an initial reaction.

### BRIEF DESCRIPTION OF DRAWINGS

FIG. 1 is a perspective view illustrating an appearance of a flat laminate type reacted all-solid-state lithium secondary battery as one embodiment of the present invention.

FIG. 2 is a cross-sectional view taken along line 2-2 illustrated in FIG. 1.

FIG. 3 shows an X-ray photoelectron spectroscopic spectrum of a reacted cell for XPS evaluation produced in Example 1.

### DESCRIPTION OF EMBODIMENTS

<Reacted all-Solid-State Battery>

One aspect of the present invention is a reacted all-solid-state battery including a power generating element including: a positive electrode in which a positive electrode active material layer containing a positive electrode active material containing a sulfur element and a sulfide solid electrolyte containing a sulfur element, a phosphorus element, and a lithium element is disposed on a surface of a positive electrode current collector; a negative electrode in which a negative electrode active material layer containing a negative electrode active material containing an alkali metal element is disposed on a surface of a negative electrode current collector; and a solid electrolyte layer interposed between the positive electrode and the negative electrode and containing a solid electrolyte, wherein in an X-ray photoelectron spectroscopic spectrum of the positive electrode active material layer, an intensity ratio (A/B) between a maximum peak A within a range of 163 to 165 eV and a maximum peak B within a range of 161 to 163 eV is 0.6 or more and 1 or less. According to the present aspect, in the all-solid-state battery including a positive electrode active material layer containing a sulfide solid electrolyte, an increase in cell resistance can be suppressed.

Hereinafter, embodiments of the present invention will be described with reference to the accompanying drawings. In the description of the drawings, the same elements are denoted by the same reference numerals, and redundant description will be omitted. Dimensional ratios in the drawings are exaggerated for convenience of description, and may be different from actual ratios.

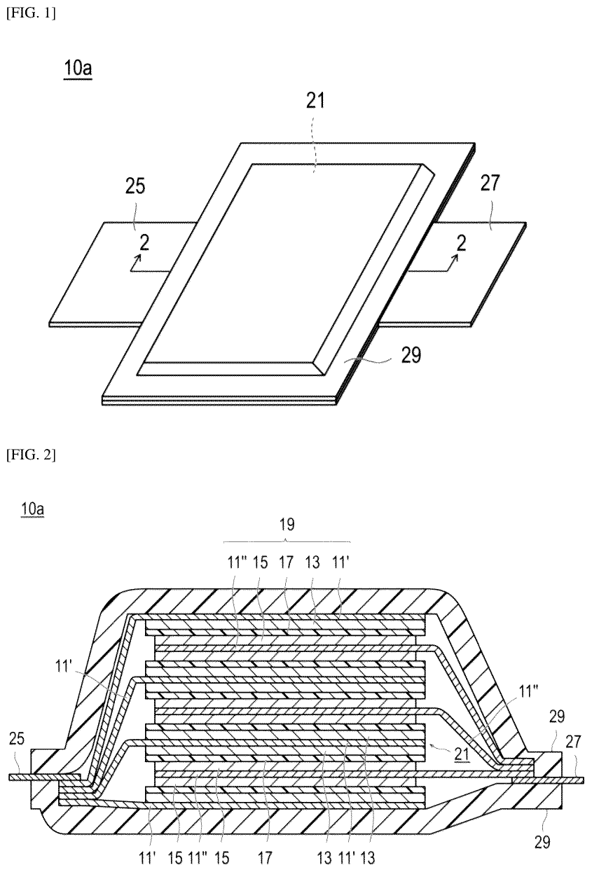

FIG. 1 is a perspective view illustrating an appearance of a flat laminate type reacted all-solid-state lithium secondary battery as one embodiment of the present invention. FIG. 2 is a cross-sectional view taken along line 2-2 illustrated in FIG. 1. The battery is formed into the laminate type, thereby allowing the battery to be compact and have a high capacity. In the present specification, a flat laminate type reacted all-solid-state lithium secondary battery (hereinafter, also simply referred to as “laminate type battery”) that is not a bipolar type illustrated in FIGS. 1 and 2 will be described in detail as an example. However, in the case of viewing the present invention in an electric connection form (electrode structure) in the reacted all-solid-state battery according to the present aspect, the present invention can be applied to both a non-bipolar type (internal parallel connection type) battery and a bipolar type (internal serial connection type) battery.

As illustrated in FIG. 1, a laminate type battery 10a has a rectangular flat shape, and a negative electrode current collecting plate 25 and a positive electrode current collecting plate 27 for extracting electric power are extended from both sides of the battery. A power generating element 21 is wrapped in a battery outer casing material (laminate film 29) of the laminate type battery 10a, the periphery of the battery outer casing material is heat-sealed, and the power generating element 21 is hermetically sealed in a state where the negative electrode current collecting plate 25 and the positive electrode current collecting plate 27 are extended to the outside.

As illustrated in FIG. 2, the laminate type battery 10a of the present embodiment has a structure in which the power generating element 21 having a flat and substantially rectangular shape in which a charge-discharge reaction actually proceeds is sealed inside the laminate film 29 as a battery outer casing material. FIG. 1 illustrates a cross section of the laminate type secondary battery at the time of full charge, and thus, a negative electrode active material layer (lithium metal layer) 13 made of lithium metal is present between a negative electrode current collector 11′ and a solid electrolyte layer 17. A restraint pressure is applied to the laminate type secondary battery 10a in a lamination direction of the power generating element 21 by a pressure member (not illustrated). Thus, the volume of the power generating element 21 is kept constant.

Here, the power generating element 21 has a configuration in which a positive electrode, a solid electrolyte layer 17, and a negative electrode are laminated. The positive electrode has a structure in which a positive electrode active material layer 15 containing a positive electrode active material (here, elemental sulfur(S)) and a sulfide solid electrolyte (here, Li₆PS₅Cl) is disposed on both surfaces of a positive electrode current collector 11″. The negative electrode has a structure in which a negative electrode active material layer 13 containing a negative electrode active material (here, lithium metal) is disposed on both surfaces of the negative electrode current collector 11′. Specifically, the positive electrode, the solid electrolyte layer, and the negative electrode are laminated in this order such that one positive electrode active material layer 15 and the negative electrode active material layer 13 adjacent thereto face each other with the solid electrolyte layer 17 interposed therebetween. Thereby, the positive electrode, the solid electrolyte layer, and the negative electrode that are adjacent constitute one single battery layer 19. Therefore, it can be said that the laminate type battery 10a illustrated in FIG. 2 has a configuration in which a plurality of single battery layers 19 are laminated to be electrically connected in parallel.

As illustrated in FIG. 2, although the negative electrode active material layer 13 is disposed on only one surface of each of outermost negative electrode current collectors located in both outermost layers of the power generating element 21, the active material layer may be provided on both surfaces. That is, instead of using a current collector exclusively for an outermost layer provided with the active material layer only on one surface thereof, a current collector provided with the active material layer on both surfaces thereof may be used as it is as an outermost current collector.

The negative electrode current collector 11′ and the positive electrode current collector 11″ have a structure in which the negative electrode current collecting plate (tab) 25 and the positive electrode current collecting plate (tab) 27 which are electrically connected to the respective electrodes (the positive electrode and the negative electrode) are respectively attached to the negative electrode current collector 11′ and the positive electrode current collector 11″ and are led to an outside of the laminate film 29 so as to be sandwiched between ends of the laminate film 29 as the battery outer casing material. The positive electrode current collecting plate 27 and the negative electrode current collecting plate 25 may be attached to the positive electrode current collector 11″ and the negative electrode current collector 11′ of the respective electrodes with a positive electrode lead and a negative electrode lead (not illustrated) interposed therebetween, respectively by ultrasonic welding, resistance welding, or the like as necessary.

Hereinafter, main constituent members of the all-solid-state battery according to the present aspect will be described.

### [Current Collector]

A current collector (positive electrode current collector, negative electrode current collector) has a function of mediating transfer of electrons from an electrode active material layer. A material constituting the current collector is not particularly limited. As a constituent material of the current collector, for example, a metal or a resin having conductivity can be adopted.

Specific examples of the metal include aluminum, nickel, iron, stainless steel, titanium, copper, and the like. In addition to these, a clad material of nickel and aluminum, a clad material of copper and aluminum, or the like may be used. A foil in which a metal surface is coated with aluminum may be used. Among them, aluminum, stainless steel, copper, and nickel are preferable from the viewpoint of the electron conductivity, the battery operating potential, the adhesion of the negative electrode active material by sputtering to the current collector, and the like.

Examples of the resin having conductivity include a resin obtained by adding a conductive filler to a non-conductive polymer material.

The current collector may have a single-layer structure made of a single material, or may have a laminated structure in which layers made of these materials are appropriately combined. From the viewpoint of weight reduction of the current collector, it is preferable that the current collector includes at least a conductive resin layer made of a resin having conductivity. From the viewpoint of blocking the movement of lithium ions between single battery layers, a metal layer may be provided in a part of the current collector.

### [Negative Electrode Active Material Layer]

The negative electrode active material layer contains a negative electrode active material. The type of the negative electrode active material is not particularly limited as long as it contains an alkali metal element, but it preferably contains lithium metal or a lithium-containing alloy, and is more preferably lithium metal or a lithium-containing alloy, and further preferably lithium metal. When the negative electrode active material is lithium metal or a lithium-containing alloy, the reacted all-solid-state battery as an electric device may be a so-called lithium-deposition type in which lithium metal as a negative electrode active material is deposited on a negative electrode current collector in a charging process. That is, in the reacted all-solid-state battery according to a preferred embodiment, lithium metal as the negative electrode active material is deposited on the negative electrode current collector during charging in the negative electrode. In such an embodiment, the thickness of the negative electrode active material layer increases with the progression of the charging process, and the thickness of the negative electrode active material layer decreases with the progression of the discharging process. The negative electrode active material layer may not be present when the battery has been completely discharged, but in some cases, a negative electrode active material layer made of a certain amount of lithium metal may be disposed when the battery has been completely discharged.

The content of the negative electrode active material in the negative electrode active material layer is not particularly limited, but for example, is preferably within a range of 40 to 99 mass %, and more preferably within a range of 50 to 90 mass %.

The negative electrode active material layer may further contain a solid electrolyte as necessary. When the negative electrode active material layer contains the solid electrolyte, the ion conductivity of the negative electrode active material layer can be improved. Examples of the solid electrolyte include a sulfide solid electrolyte and an oxide solid electrolyte, and a sulfide solid electrolyte is preferable.

Examples of the sulfide solid electrolyte include LiI—Li₂S—SiS₂, LiI—Li₂S—P₂O₅, LiI—Li₃PO₄—P₂S₅, Li₂S—P₂S₅, LiI—Li₃PS₄, LiI—LiBr—Li₃PS₄, Li₃PS₄, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any of Ge, Zn, and Ga), Li₂S—GeS₂, Li₂S—SiS₂—Li₃PO₄, Li₂S—SiS₂-LiₓMO_{y} (where x and y are positive numbers, and M is any of P, Si, Ge, B, Al, Ga, and In), and the like. The description of “Li₂S—P₂S₅” means a sulfide solid electrolyte obtained by using a raw material composition containing Li₂S and P₂S₅, and the same applies to other descriptions.

The sulfide solid electrolyte may have, for example, a Li₃PS₄ skeleton, a Li₄P₂S₇ skeleton, or a Li₄P₂S₆ skeleton. Examples of the sulfide solid electrolyte having a Li₃PS₄ skeleton include LiI—Li₃PS₄, LiI—LiBr—Li₃PS₄, and Li₃PS₄. Examples of the sulfide solid electrolyte having a Li₄P₂S₇ skeleton include a Li—P—S-based solid electrolyte (for example, Li₂P₃S₁₁) called LPS. As the sulfide solid electrolyte, for example, LGPS represented by Li₍₄₋ₓ₎Ge₍₁₋ₓ₎PₓS₄ (x satisfies 0<x<1) or the like may be used. Among them, the sulfide solid electrolyte is preferably a sulfide solid electrolyte containing a P element and more preferably a material containing Li₂S—P₂S₅ as a main component. The sulfide solid electrolyte may contain halogen (F, Cl, Br, I). In one preferred embodiment, the sulfide solid electrolyte contains Li₆PS₅X (where X is Cl, Br, or I, preferably Cl).

When the sulfide solid electrolyte is Li₂S—P₂S₅-based, a ratio of Li₂S and P₂S₅ in terms of molar ratio is preferably within a range of Li₂S:P₂S₅=50:50 to 100:0, and particularly preferably within a range of Li₂S:P₂S₅=70:30 to 80:20.

The sulfide solid electrolyte may be sulfide glass, crystallized sulfide glass, or a crystalline material obtained by a solid phase method. The sulfide glass can be obtained, for example, by performing mechanical milling (ball milling or the like) on a raw material composition. The crystallized sulfide glass can be obtained, for example, by heat-treating sulfide glass at a temperature equal to or higher than a crystallization temperature. The ion conductivity (for example, Li ion conductivity) of the sulfide solid electrolyte at a normal temperature (25° C.) is, for example, preferably 1×10⁻⁵ S/cm or more and more preferably 1×10⁻⁴ S/cm or more. A value of the degree of ionic conductivity of the solid electrolyte can be measured by an AC impedance method.

Examples of the shape of the solid electrolyte include a particle shape such as a perfect spherical shape and an elliptical spherical shape, a thin film shape, and the like. When the solid electrolyte has a particle shape, the average particle size (D50) thereof is not particularly limited, but is preferably 40 μm or less, more preferably 20 μm or less, and further preferably 10 μm or less. The average particle size (D50) is preferably 0.01 μm or more and more preferably 0.1 μm or more. In the present specification, as the value of the “average particle size”, a value calculated as an average value of the particle sizes of the particles observed in several to several dozen visual fields using an observation means such as a scanning electron microscope (SEM) or a transmission electron microscope (TEM) is adopted.

A content of the solid electrolyte in the negative electrode active material layer is, for example, preferably within a range of 1 to 60 mass % and more preferably within a range of 10 to 50 mass %.

The negative electrode active material layer may further contain at least one of a conductive aid and a binder in addition to the negative electrode active material and the solid electrolyte described above.

The thickness of the negative electrode active material layer varies depending on the configuration of the intended reacted all-solid-state battery, but is, for example, preferably within a range of 0.1 to 1000 μm.

### [Solid Electrolyte Layer]

The solid electrolyte layer is interposed between the positive electrode active material layer and the negative electrode active material layer and contains a solid electrolyte.

A specific form of the solid electrolyte contained in the solid electrolyte layer is not particularly limited, and examples and preferred forms of the solid electrolyte described in the section of the negative electrode active material layer are adopted in the same manner. In some cases, solid electrolytes other than the solid electrolyte described above may be used in combination.

The solid electrolyte layer may further contain a binder in addition to the predetermined solid electrolyte described above.

The thickness of the solid electrolyte layer varies depending on the configuration of the intended reacted all-solid-state battery, but is preferably 600 μm or less, more preferably 500 μm or less, and still more preferably 400 μm or less, from the viewpoint that the volume energy density of the battery can be improved. Meanwhile, the lower limit value of the thickness of the solid electrolyte layer is not particularly limited, but is preferably 1 μm or more, more preferably 5 μm or more, and still more preferably 10 μm or more.

### [Positive Electrode Active Material Layer]

In the present aspect, the positive electrode active material layer is characterized by containing a positive electrode active material containing a sulfur element and a sulfide solid electrolyte containing a sulfur element, a phosphorus element, and a lithium element.

The type of the positive electrode active material is not particularly limited as long as it consists or contains a sulfur element, but examples thereof include particles or a thin film of an organic sulfur compound or an inorganic sulfur compound in addition to the elemental sulfur(S) and lithium sulfide (Li₂S), and any material may be used as long as the material can release lithium ions during charging and occlude lithium ions during discharging by utilizing an oxidation-reduction reaction of sulfur. Examples of the organic sulfur compound may be selected from a disulfide compound, sulfur-modified polyacrylonitrile typified by the compound described in WO 2010/044437 A, sulfur-modified polyisoprene, rubeanic acid (dithiooxamide), carbon polysulfide, and the like. Meanwhile, the inorganic sulfur compound is preferable because it is excellent in stability, and specific examples thereof include elemental sulfur(S), lithium sulfide (Li₂S), S-carbon composite, TiS₂, TiS₃, TiS₄, NiS, NiS₂, CuS, FeS₂, Li₂S, MoS₂, MoS₃, MnS, MnS₂, CoS, CoS₂, and the like. Among them, S, lithium sulfide (Li₂S), S-carbon composite, TiS₂, TiS₃, TiS₄, FeS₂, and MoS₂ are preferable, elemental sulfur(S), lithium sulfide (Li₂S), TiS₂, and FeS₂ are more preferable, and elemental sulfur(S) and lithium sulfide (Li₂S) are particularly preferable from the viewpoint of high capacity. As the elemental sulfur(S), α-sulfur, β-sulfur, or γ-sulfur having a S₈ structure can be used.

The content of the positive electrode active material containing a sulfur element in the positive electrode active material layer is not particularly limited, but is preferably 30 mass % or more and 80 mass % or less, more preferably 40 mass % or more and 70 mass % or less, and particularly preferably 45 mass % or more and 60 mass % or less, with respect to 100 mass % of the total mass of the positive electrode active material layer.

The sulfide solid electrolyte is not particularly limited as long as it contains a sulfur element, a phosphorus element, and a lithium element, and the solid electrolyte exemplified in the section of the negative electrode active material layer can be similarly employed. Among them, Li₃PS₄, Li₂P₃S₁₁, Li₍₄₋ₓ₎Ge₍₁₋ₓ₎PₓS₄ (x satisfies 0<x<1), and Li₆PS₅X (where X is Cl, Br, or I, preferably Cl) are preferable, Li₆PS₅X (where X is Cl, Br, or I) is more preferable, and Li₆PS₅Cl is further preferable. By performing charging as an initial reaction in the following method for manufacturing a reacted all-solid-state battery, an oxidation reaction product can be generated on the surface of the sulfide solid electrolyte. For example, in Examples 1 to 5 described later, P₂S₅ which is a phosphorus sulfide compound is generated as an oxidation reaction product. Since the oxidation reaction product can reversibly repeat reduction and oxidation in subsequent discharge and charge, it is possible to prevent the reductive decomposition of the sulfide solid electrolyte, and as a result, it is possible to suppress an increase in cell resistance.

The content of the sulfide solid electrolyte containing a sulfur element, a phosphorus element, and a lithium element in the positive electrode active material layer is not particularly limited, but is preferably 10 mass % or more and 60 mass % or less, more preferably 20 mass % or more and 50 mass % or less, and further preferably 30 mass % or more and 45 mass % or less, with respect to 100 mass % of the total mass of the positive electrode active material layer.

The positive electrode active material layer may contain a conductive aid in order to improve electron conductivity in the active material layer. The conductive aid is not particularly limited, and examples thereof include metals such as aluminum, stainless steel (SUS), silver, gold, copper, and titanium, alloys or metal oxides containing these metals; carbon fibers (specifically, vapor grown carbon fibers (VGCF), polyacrylonitrile-based carbon fibers, pitch-based carbon fibers, rayon-based carbon fibers, activated carbon fibers, and the like), and the like. It is also preferable to use porous carbon as the conductive aid. In the case of using porous carbon, sulfur utilization efficiency can be further improved by containing a sulfur-impregnated carbon composite material in which sulfur is impregnated into pores of porous carbon in the positive electrode active material layer. Examples of the porous carbon include carbon black such as activated carbon, Ketjen black (registered trademark) (highly conductive carbon black), (oil) furnace black, channel black, acetylene black, thermal black, and lamp black, and carbon particles (carbon carriers) made of coke, natural graphite, artificial graphite, and the like. A mold such as ceramics and a carbon raw material such as a resin are mixed and fired in an inert atmosphere, the mold is then melted with an acid to synthesize a conductive porous body having a porous structure to which the shape of the mold is transferred, and this conductive porous body may be used. At this time, a pore size and a pore volume of the obtained conductive porous body can be changed by appropriately adjusting the particle size of the mold and the blending ratio of the carbon raw material.

The BET specific surface area of the porous carbon is preferably 200 m²/g or more, more preferably 500 m²/g or more, further preferably 800 m²/g or more, particularly preferably 1200 m²/g or more, and most preferably 1500 m²/g or more. The total pore volume of the porous carbon is preferably 1.0 mL/g or more, more preferably 1.3 mL/g or more, and further preferably 1.5 mL/g or more. When the BET specific surface area and the pore volume of the porous carbon are values within such ranges, a sufficient number of pores can be held, and thus a sufficient amount of elemental sulfur(S) and/or lithium sulfide (Li₂S) can be held. The values of the BET specific surface area and the pore volume of the porous carbon can be measured by measurement based on adsorption and desorption of nitrogen. The measurement based on adsorption and desorption of nitrogen is performed using BELSORP mini manufactured by MicrotracBEL Corp., and is performed by a multipoint method at a temperature of −196° C. The BET specific surface area is determined from the adsorption isotherm in a relative pressure range of 0.01<P/P₀<0.05. The pore volume is determined from the volume of the adsorbed N₂ at a relative pressure of 0.96.

The content of the conductive aid in the positive electrode active material layer is not particularly limited, but is preferably 1 mass % or more and 30 mass % or less, and more preferably 5 mass % or more and 20 mass % or less, with respect to 100 mass % of the total mass of the positive electrode active material layer.

The reacted all-solid-state battery according to the present aspect is also characterized in that in an X-ray photoelectron spectroscopic (XPS) spectrum of the positive electrode active material layer, the intensity ratio (A/B) between the maximum peak A within a range of 163 to 165 eV and the maximum peak B within a range of 161 to 163 eV is 0.6 or more and 1 or less. Here, according to the XPS spectrum, quantitative analysis of each element can be performed by peak intensity, but the maximum peak A thought to be derived from —S—S— and —P—S—P— is observed within a range of 163 to 165 eV, and the maximum peak B thought to be derived from the sulfide solid electrolyte (Li₆PS₅Cl) is observed within a range of 161 to 163 eV (preferably, within a range of 161 eV or more and less than 163 eV). When the intensity ratio (A/B) of these peaks is 0.6 or more and 1 or less, the reductive decomposition of the sulfide solid electrolyte is less likely to occur in the reacted all-solid-state battery, and an increase in cell resistance can be suppressed. Since an increase in cell resistance can be further suppressed, the peak intensity ratio (A/B) is preferably 0.64 or more and 1 or less, more preferably 0.71 or more and 1 or less, further preferably 0.82 or more and 1 or less, and particularly preferably 0.90 or more and 1 or less. As shown in Examples 1 to 5 described later, the value of the peak intensity ratio (A/B) can be brought closer to 1 by controlling the limit voltage (charge upper limit voltage) in the first charge within a range of 3 V or less and controlling the charge density in the first charge within a range of 0.3 mA/cm² or less.

### [Positive Electrode Current Collecting Plate and Negative Electrode Current Collecting Plate]

A material constituting the current collecting plates (25 and 27) is not particularly limited, and a known highly conductive material conventionally used as a current collecting plate for a secondary battery can be used. As a constituent material of the current collecting plate, for example, a metal material such as aluminum, copper, titanium, nickel, stainless steel (SUS), or an alloy thereof is preferable. From the viewpoint of weight reduction, corrosion resistance, and high conductivity, aluminum and copper are more preferable, and aluminum is particularly preferable. The same material or different materials may be used for the positive electrode current collecting plate 27 and the negative electrode current collecting plate 25.

### [Positive Electrode Lead and Negative Electrode Lead]

Although not illustrated, the current collector and the current collecting plate may be electrically connected with a positive electrode lead or a negative electrode lead interposed therebetween. As a constituent material of the positive electrode and negative electrode leads, a material used in a known all-solid-state battery can be similarly adopted. The portion taken out from an outer casing is preferably covered with a heat resistant and insulating heat shrinkable tube or the like so as not to affect a product (for example, an automotive component, particularly an electronic device, or the like) due to electric leakage caused by contact with peripheral devices, wiring lines, or the like.

### [Battery Outer Casing Material]

As the battery outer casing material, a known metal can case can be used, and a bag-shaped case using the laminate film 29 containing aluminum, which can cover a power generating element as illustrated in FIGS. 1 and 2, can be used. As the laminate film, for example, a laminate film having a three-layer structure formed by laminating PP, aluminum, and nylon in this order can be used, but the laminate film is not limited thereto at all. From the viewpoint of excellent high output and cooling performance, and suitable application for batteries for large devices for EV and HEV, a laminate film is desirable. Since the group pressure applied to the power generating element from the outside can be easily adjusted, the outer casing is more preferably a laminate film containing aluminum.

The laminate type battery according to the present aspect has a configuration in which a plurality of single battery layers are connected in parallel, and thus has a high capacity and excellent cycle durability. Therefore, the laminate type battery according to the present aspect is suitably used as a power source for driving EV and HEV.

Although one embodiment of the reacted all-solid-state battery has been described above, the present invention is not limited to only the configurations described in the above-described embodiment, and can be appropriately changed based on the description of the claims.

<Method for Manufacturing Reacted all-Solid-State Battery>

The above-described reacted all-solid-state battery includes a power generating element including a predetermined positive electrode, a solid electrolyte layer, and a negative electrode, and can be manufactured by charging an unreacted all-solid-state battery, which is not charged or discharged, as an initial reaction. That is, in a method for manufacturing a reacted all-solid-state battery according to another aspect of the present invention, the reacted all-solid-state battery includes a power generating element including: a positive electrode in which a positive electrode active material layer containing a positive electrode active material containing a sulfur element and a sulfide solid electrolyte containing a sulfur element, a phosphorus element, and a lithium element is disposed on a surface of a positive electrode current collector; a negative electrode in which a negative electrode active material layer containing a negative electrode active material containing an alkali metal element is disposed on a surface of a negative electrode current collector; and a solid electrolyte layer interposed between the positive electrode and the negative electrode and containing a solid electrolyte, and the method is characterized by including a charging step of charging an unreacted all-solid-state battery, which is not charged or discharged, as an initial reaction. According to the present aspect, in the all-solid-state battery including a positive electrode active material layer containing a sulfide solid electrolyte, an increase in cell resistance can be suppressed.

An unreacted all-solid-state battery including a predetermined power generating element can be easily produced by a person skilled in the art by appropriately referring to a conventionally known method, and thus description of a specific production method is omitted here.

The manufacturing method according to the present aspect includes a charging step of charging an unreacted all-solid-state battery, which is not charged or discharged, as an initial reaction. Conventionally, an unreacted all-solid-state battery including a positive electrode active material layer containing a positive electrode active material containing a sulfur element (for example, elemental sulfur(S)) has occluded an alkali metal (for example, lithium) in the positive electrode active material by performing discharge (reduction) as an initial reaction. During the discharge as the initial reaction, a reduction reaction product (for example, lithium phosphide such as LiP₇, Li₃P₇, or LiP) can be generated on the surface of the sulfide solid electrolyte. The reduction reaction product generates an oxidative decomposition product by subsequent charging, but since this reaction is an irreversible reaction, the oxidative decomposition product accumulates on the surface of the sulfide solid electrolyte by repeating the charge-discharge reaction. As a result, the ion conductivity of the sulfide solid electrolyte decreases, leading to an increase in cell resistance. On the other hand, the present invention is characterized in starting from charge (oxidation) which is a reaction in a direction opposite to the conventional direction. As a result, an oxidation reaction product (phosphorus sulfide compound such as P₂S₅) is generated on the surface of the sulfide solid electrolyte. Since the oxidation reaction product can reversibly repeat reduction and oxidation in subsequent discharge and charge, it is possible to prevent the reductive decomposition of the sulfide solid electrolyte, and as a result, it is possible to suppress an increase in cell resistance.

The charge upper limit voltage in the charging step is not particularly limited, but is preferably 4 V vs. Li/Li⁺ or less, and more preferably 3 V vs. Li/Li⁺ or less. By setting the value of the charge upper limit voltage within the above range, oxidative decomposition of the sulfide solid electrolyte can be suppressed due to charge (oxidation) in a high voltage region. The lower limit value of the charge upper limit voltage is not particularly limited, but is preferably 2.3 V vs. Li/Li⁺ or more, and more preferably 2.5 V vs. Li/Li⁺ or more.

The current density in the charging step is also not particularly limited, but is preferably 12 mA/cm² or less, more preferably 1 mA/cm² or less, further preferably 0.3 mA/cm² or less, particularly preferably 0.1 mA/cm² or less, and most preferably 0.03 mA/cm² or less. By setting the value of the current density within the above range, the oxidation reaction of the sulfide solid electrolyte in the positive electrode active material layer can uniformly proceed. As a result, an increase in cell resistance can be further suppressed.

The cell temperature in the charging step is preferably controlled within a range of 10° C. or higher and 70° C. or lower, more preferably within a range of 20° C. or higher and 60° C. or lower, and further preferably within a range of 25° C. or higher and 40° C. or lower, from the viewpoint of uniformly advancing the oxidation reaction of the sulfide solid electrolyte in the positive electrode active material layer.

After the charging step as the initial reaction, as necessary, discharging may be performed once, or discharging and charging may be repeated about 1 to 10 times.

The following embodiments are also included in the scope of the present invention: the reacted all-solid-state battery according to claim 1 having the feature of claim 2; the reacted all-solid-state battery according to claim 1 or 2 having the feature of claim 3; the reacted all-solid-state battery according to any one of claims 1 to 3 having the feature of claim 4; the method for manufacturing a reacted all-solid-state battery according to claim 5 having the feature of claim 6; the method for manufacturing a reacted all-solid-state battery according to claim 6 having the feature of claim 7; the method for manufacturing a reacted all-solid-state battery according to any one of claims 5 to 7 having the feature of claim 8; and the method for manufacturing a reacted all-solid-state battery according to claim 8 having the feature of claim 9.

### EXAMPLES

Hereinafter, the present invention will be described in more detail with reference to Examples. However, the technical scope of the present invention is not limited only to the following Examples. In the following description, the instruments, devices, and the like used in the glove box were sufficiently dried in advance.

### <Preparation of Positive Electrode Mixture>

In a glove box in an argon atmosphere with a dew point of −68° C. or lower, 40 g of 5 mm zirconia balls, 0.100 g of sulfur (manufactured by Aldrich) as a positive electrode active material, 0.020 g of Ketjen black (registered trademark) EC600JD (manufactured by LION SPECIALTY CHEMICALS CO., LTD.) as a conductive aid, and 0.080 g of Li₆PS₅Cl (manufactured by Ampcera Inc.) as a sulfide solid electrolyte were placed in a 45 mL zirconia container, and treated in a planetary ball mill (Premium line P-7 manufactured by Fritsch Japan Co., Ltd.) at 370 rpm for 6 hours to obtain a positive electrode mixture powder. The composition of the positive electrode mixture was sulfur:conductiveaid:sulfide solid electrolyte=50:10:40 (mass ratio).

<Production of Unreacted Cell (Unreacted all-Solid-State Lithium Secondary Battery)>

An unreacted cell was produced in a glove box in an argon atmosphere with a dew point of −68° C. or lower. A cylindrical convex punch (10 mm diameter, also serving as a negative electrode current collector) made of stainless steel was inserted into one side of a cylindrical tube jig (tube inner diameter: 10 mm, outer diameter: 23 mm, height: 20 mm) made of Macor, and 80 mg of Li₆PS₅Cl (manufactured by Ampcera Inc.) as a sulfide solid electrolyte was inserted from the upper side of the cylindrical tube jig. Thereafter, another cylindrical convex punch made of stainless steel was inserted into the jig to sandwich the sulfide solid electrolyte, and the sulfide solid electrolyte was pressed using an oil hydraulic press at a pressure of 75 MPa for 3 minutes to form a solid electrolyte layer having a diameter of 10 mm and a thickness of about 0.6 mm in the cylindrical tube jig. Next, the cylindrical convex punch inserted from the upper side was once removed, 7.5 mg of the positive electrode mixture prepared above was added to one side surface of the solid electrolyte layer in the cylindrical tube, and the cylindrical convex punch (also serving as a positive electrode current collector) was inserted again from the upper side and pressed at a pressure of 300 MPa for 3 minutes to form a positive electrode active material layer having a diameter of 10 mm and a thickness of about 0.06 mm on one side surface of the solid electrolyte layer. Then, the lower side of the cylindrical convex punch (also serving as a negative electrode current collector) was removed, a lithium foil (manufactured by The Nilaco Corporation, thickness: 0.20 mm) punched to a diameter of 8 mm and an indium foil (manufactured by The Nilaco Corporation, thickness: 0.30 mm) punched to a diameter of 9 mm as negative electrodes were overlapped, the overlapped foil was put in from the lower side of the cylindrical tube jig such that the indium foil was located on the solid electrolyte layer side, and the cylindrical convex punch was inserted again, and pressed at a pressure of 75 MPa for 3 minutes to form a lithium-indium negative electrode. As described above, an unreacted cell (unreacted all-solid-state lithium secondary battery) including a negative electrode current collector (punch), a lithium-indium negative electrode, a solid electrolyte layer, a positive electrode active material layer, and a positive electrode current collector (punch) laminated in this order was produced.

<Production of Reacted Cell (Reacted all-Solid-State Lithium Secondary Battery)>

An initial reaction (charge reaction or discharge reaction) and a subsequent charge/discharge reaction were performed on the unreacted cell produced above by the following method to produce a reacted cell (reacted all-solid-state lithium secondary battery). The initial reaction (charge reaction or discharge reaction) and the subsequent charge reaction and charge/discharge characteristics evaluation were performed in a constant temperature thermostatic bath set at 25° C. using a charge/discharge test apparatus (HJ-SD8 manufactured by HOKUTO DENKO CORPORATION).

### Comparative Example 1

A battery was placed in a thermostatic bath, and after the cell temperature became constant, constant current discharge was performed up to a cell voltage of 0.5 V at a current density of 0.3 mA/cm², and subsequently, constant current constant voltage charge of 2.5 V and constant current constant voltage discharge of 0.5 V were performed at the same current density while setting a cutoff current to 0.01 mA/cm². Thereafter, a cycle in which constant current constant voltage charge of 2.5 V was performed at a current density of 0.6 mA/cm² while setting a cutoff current to 0.01 mA/cm², and subsequently constant current discharge was performed up to 0.5 V at the same current density was repeated three times, and the resulting cell was used as a reacted cell for XPS evaluation of this comparative example. The cell obtained by repeating the cycle 5 times was used as a reacted cell for DC resistance (DCR) evaluation of this comparative example.

### Example 1

A battery was placed in a thermostatic bath, and after the cell temperature became constant, constant current constant voltage charge of 4 V was performed at a current density of 0.3 mA/cm² while setting a cutoff current to 0.01 mA/cm², and subsequently, constant current discharge was performed up to 0.5 V at the same current density. Thereafter, a cycle in which constant current constant voltage charge of 2.5 V was performed at a current density of 0.6 mA/cm² while setting a cutoff current to 0.01 mA/cm², and subsequently constant current discharge was performed up to 0.5 V at the same current density was repeated three times, and the resulting cell was used as a reacted cell for XPS evaluation of this example. The cell obtained by repeating the cycle 5 times was used as a reacted cell for DC resistance (DCR) evaluation of this example.

### Example 2

A battery was placed in a thermostatic bath, and after the cell temperature became constant, constant current constant voltage charge of 3 V was performed at a current density of 0.3 mA/cm² while setting a cutoff current to 0.01 mA/cm², and subsequently, constant current discharge was performed up to 0.5 V at the same current density. Thereafter, a cycle in which constant current constant voltage charge of 2.5 V was performed at a current density of 0.6 mA/cm² while setting a cutoff current to 0.01 mA/cm², and subsequently constant current discharge was performed up to 0.5 V at the same current density was repeated three times, and the resulting cell was used as a reacted cell for XPS evaluation of this example. The cell obtained by repeating the cycle 5 times was used as a reacted cell for DC resistance (DCR) evaluation of this example.

### Example 3

A battery was placed in a thermostatic bath, and after the cell temperature became constant, constant current constant voltage charge of 2.3 V was performed at a current density of 0.3 mA/cm² while setting a cutoff current to 0.01 mA/cm², and subsequently, constant current discharge was performed up to 0.5 V at the same current density. Thereafter, a cycle in which constant current constant voltage charge of 2.5 V was performed at a current density of 0.6 mA/cm² while setting a cutoff current to 0.01 mA/cm², and subsequently constant current discharge was performed up to 0.5 V at the same current density was repeated three times, and the resulting cell was used as a reacted cell for XPS evaluation of this example. The cell obtained by repeating the cycle 5 times was used as a reacted cell for DC resistance (DCR) evaluation of this example.

### Example 4

A battery was placed in a thermostatic bath, and after the cell temperature became constant, constant current constant voltage charge of 3 V was performed at a current density of 0.03 mA/cm² while setting a cutoff current to 0.01 mA/cm², and subsequently, constant current discharge was performed up to 0.5 V at the same current density. Thereafter, a cycle in which constant current constant voltage charge of 2.5 V was performed at a current density of 0.6 mA/cm² while setting a cutoff current to 0.01 mA/cm², and subsequently constant current discharge was performed up to 0.5 V at the same current density was repeated three times, and the resulting cell was used as a reacted cell for XPS evaluation of this example. The cell obtained by repeating the cycle 5 times was used as a reacted cell for DC resistance (DCR) evaluation of this example.

### Example 5

A battery was placed in a thermostatic bath, and after the cell temperature became constant, constant current constant voltage charge of 3 V was performed at a current density of 12 mA/cm² while setting a cutoff current to 0.01 mA/cm², and subsequently, constant current discharge was performed up to 0.5 V at the same current density. Thereafter, a cycle in which constant current constant voltage charge of 2.5 V was performed at a current density of 0.6 mA/cm² while setting a cutoff current to 0.01 mA/cm², and subsequently constant current discharge was performed up to 0.5 V at the same current density was repeated three times, and the resulting cell was used as a reacted cell for XPS evaluation of this example. The cell obtained by repeating the cycle 5 times was used as a reacted cell for DC resistance (DCR) evaluation of this example.

### <X-Ray Photoelectron Spectroscopy (XPS) Measurement>

For the reacted cell for XPS evaluation produced in each of Examples and Comparative Examples, the X-ray photoelectron spectroscopy (XPS) measurement was performed by the following method. In a glove box in an argon atmosphere with a dew point of −68° C. or lower, the reacted cell for XPS evaluation was disassembled, and the positive electrode active material layer was crushed to prepare a powdery sample. The powder sample was fixed to a sample holder using an indium foil, introduced into a composite electron spectrometer (ESCA 5800 manufactured by ULVAC-PHI, INC.) without being exposed to the atmosphere using a transfer vessel, and subjected to X-ray photoelectron spectroscopy.
X-ray source: AlKα ray (1486.6 eV)
X-ray output: 25 W 15 kV
Detection area: 100 μmφ
Detection depth: several nm (extraction angle 45°)

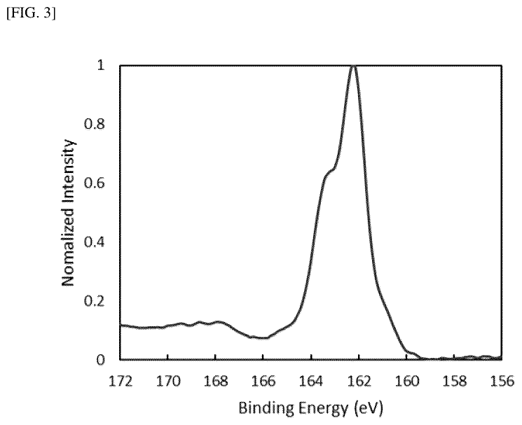

In the obtained X-ray photoelectron spectroscopic spectrum, a peak intensity ratio (A/B) was calculated from the maximum peak A within a range of 163 to 165 eV and the maximum peak B within a range of 161 to 163 eV. The results are shown in Table 1 below. FIG. 3 shows an X-ray photoelectron spectroscopic spectrum (obtained by normalizing the relative intensity of the maximum peak B within a range of 161 to 163 eV to 1) of the reacted cell for XPS evaluation produced in Example 1.

### <Confirmation of Phosphorus Sulfide Compound>

For the reacted cell for XPS evaluation produced in each of Examples and Comparative Examples, the presence or absence of a phosphorus sulfide compound was confirmed using an X-ray diffraction (XRD) method by the following method. In a glove box in an argon atmosphere with a dew point of −68° C. or lower, the reacted cell for XPS evaluation was disassembled, and the positive electrode active material layer was crushed to prepare a powdery sample. The powder sample was subjected to powder X-ray diffraction measurement. SmartLab manufactured by Rigaku Corporation was used for the measurement, and the measurement was performed under the following conditions.
Scan speed (2θ/θ): 2°/min
Step width (2θ/θ): 0.02°
Radiation source: CuKα: λ=1.5418 Å.

In the X-ray diffraction spectrum measured for each of the reacted cells for XPS evaluation of Examples 1 to 5, a peak derived from P₂S₅ was observed in the vicinity of 2θ=30 to 33°. On the other hand, in the X-ray diffraction spectrum measured for the reacted cell for XPS evaluation of Comparative Example 1, a peak derived from P₂S₅ was not confirmed in the vicinity of 2θ=30 to 33°. From these results, in each of the reacted cells for XPS evaluation of Examples 1 to 5, it was confirmed that P₂S₅ as a phosphorus sulfide compound was contained in the positive electrode active material layer. It was considered that this P₂S₅ was generated by the first charging.

### <Measurement of DC Resistance (DCR)>

For the reacted cell for DC resistance (DCR) evaluation produced in each of Examples and Comparative Examples, the DC resistance (DCR) was measured by the following method. The measurement was performed in a constant temperature thermostat bath set at 25° C. using a charge-discharge test device (HJ-SD8 manufactured by HOKUTO DENKO CORPORATION). A battery was placed in a thermostatic bath, and after the cell temperature became constant, constant current constant voltage charge of 2.5 V was performed at a current density of 0.6 mA/cm² while setting a cutoff current to 0.01 mA/cm², and subsequently, constant current discharge was performed up to 0.5 V at the same current density. The capacity value (mAh/g) per mass of the positive electrode active material was calculated from the value of the charge/discharge capacity at this time and the mass of the positive electrode active material (sulfur) contained in the positive electrode. Next, constant current discharge was performed at a current density of 0.2 mA/cm² up to a capacity of 50% (SOC 50%) with respect to the capacity value of 100% calculated in this way. After pausing of 30 minutes, discharge was performed at a discharge rate of 1 C for 10 seconds, and a DC resistance value (DCR) was calculated from a voltage drop amount and a current value at that time according to Ohm's law. The results are shown in Table 1 below.

TABLE 1

| | Initial reaction | | | XPS peak | |
|---|---|---|---|---|---|
| | Reaction | Limit voltage | Current density | intensity | DCR |
| | direction | (V vs. Li/Li⁺) | (mA/cm²) | (A/B) | (Ω · cm²) |
| Comparative | Discharge | 1 | 0.3 | 0.52 | 851 |
| Example 1 | | | | | |
| Example 1 | Charge | 4 | 0.3 | 0.64 | 628 |
| Example 2 | | 3 | 0.3 | 0.82 | 452 |
| Example 3 | | 2.3 | 0.3 | 0.71 | 483 |
| Example 4 | | 3 | 0.03 | 0.90 | 445 |
| Example 5 | | 3 | 12 | 0.61 | 736 |

As shown in Table 1, according to the present invention, in the X-ray photoelectron spectroscopic spectrum for the positive electrode active material layer, the peak intensity ratio (A/B) is within a range of 0.6 or more and 1 or less, whereby an increase in cell resistance can be suppressed. As shown in Table 1, the peak intensity ratio (A/B) can be controlled within a range of 0.6 or more and 1 or less by setting the initial reaction after cell assembly as a charge reaction. From the results in Table 1, it is also found effective to control the limit voltage (charge upper limit voltage) in the first charge within a range of 3 V vs. Li/Li⁺ or less and to control the charge density in the first charge within a range of 0.3 mA/cm² or less in order to further suppress an increase in cell resistance.

### REFERENCE SIGNS LIST

10a Laminate type battery
11′ Negative electrode current collector
11″ Positive electrode current collector
13 Negative electrode active material layer
15 Positive electrode active material layer
17 Solid electrolyte layer
19 Single battery layer
21 Power generating element
25 Negative electrode current collecting plate
27 Positive electrode current collecting plate
29 Laminate film

1.-9. (canceled)

10. A method for manufacturing a reacted all-solid-state battery, the reacted all-solid-state battery including a power generating element including:
a positive electrode in which a positive electrode active material layer containing a positive electrode active material containing a sulfur element and a sulfide solid electrolyte containing a sulfur element, a phosphorus element, and a lithium element is disposed on a surface of a positive electrode current collector;
a negative electrode in which a negative electrode active material layer containing a negative electrode active material containing an alkali metal element is disposed on a surface of a negative electrode current collector; and
a solid electrolyte layer interposed between the positive electrode and the negative electrode and containing a solid electrolyte,
the method comprising a charging step of charging an unreacted all-solid-state battery, which is not charged or discharged, as an initial reaction,
wherein the positive electrode active material containing a sulfur element is at least one selected from the group consisting of elemental sulfur, a disulfide compound, sulfur-modified polyacrylonitrile, sulfur-modified polyisoprene, rubeanic acid, carbon polysulfide, S-carbon composite, TiS₂, TiS₃, TiS₄, NiS, NiS₂, CuS, FeS₂, MoS₂, MOS₃, MnS, MnS₂, CoS, and CoS₂, and
the positive electrode active material in the positive electrode active material layer is a material capable of releasing lithium ions during charging and occluding lithium ions during discharging by utilizing an oxidation-reduction reaction of sulfur.

11. The method for manufacturing a reacted all-solid-state battery according to claim 10, wherein a charge upper limit voltage in the charging step is 4 V vs. Li/Li⁺ or less.

12. The method for manufacturing a reacted all-solid-state battery according to claim 11, wherein the charge upper limit voltage in the charging step is 3 V vs. Li/Li⁺ or less.

13. The method for manufacturing a reacted all-solid-state battery according to claim 10, wherein a current density in the charging step is 12 mA/cm² or less.

14. The method for manufacturing a reacted all-solid-state battery according to claim 13, wherein the current density in the charging step is 0.3 mA/cm² or less.

15. The method for manufacturing a reacted all-solid-state battery according to claim 10, wherein the positive electrode current collector is at least one selected from the group consisting of aluminum, nickel, iron, stainless steel, titanium, copper and a resin having conductivity.

16. A reacted all-solid-state battery manufactured by the method for manufacturing according to claim 10, the reacted all-solid-state battery comprising a power generating element including:
a positive electrode in which a positive electrode active material layer containing a positive electrode active material containing a sulfur element and a sulfide solid electrolyte containing a sulfur element, a phosphorus element, and a lithium element is disposed on a surface of a positive electrode current collector;
a negative electrode in which a negative electrode active material layer containing a negative electrode active material containing an alkali metal element is disposed on a surface of a negative electrode current collector; and
a solid electrolyte layer interposed between the positive electrode and the negative electrode and containing a solid electrolyte,
wherein in an X-ray photoelectron spectroscopic spectrum of the positive electrode active material layer of the reacted all-solid-state battery, an intensity ratio (A/B) between a maximum peak A within a range of 163 to 165 eV and a maximum peak B within a range of 161 to 163 eV is 0.6 or more and 1 or less.

17. The reacted all-solid-state battery according to claim 16, wherein in the negative electrode of the reacted all-solid-state battery, lithium metal as the negative electrode active material is deposited on the negative electrode current collector during charging.

18. The reacted all-solid-state battery according to claim 16, wherein the positive electrode active material layer of the reacted all-solid-state battery further contains a phosphorus sulfide compound.

19. The reacted all-solid-state battery according to claim 16, wherein the sulfide solid electrolyte of the reacted all-solid-state battery is at least one selected from Li₆PS₅X, wherein X is Cl, Br, or I.
